(19) United States
(12) Patent Application Publication
(10) Pub. No.: US 2025/0224150 A1
(43) Pub. Date: Jul. 10, 2025

(54) SYSTEM AND METHOD FOR GEOTHERMAL ENERGY PRODUCTION

(71) Applicant: GreenFire Energy Inc., Walnut Creek, CA (US)

(72) Inventors: Greg Szutiak, Calgary (CA); Alan D. Eastman, Holladay, UT (US); John R. Muir, St. George, UT (US)

(73) Assignee: GreenFire Energy Inc., Walnut Creek, CA (US)

(21) Appl. No.: 19/011,389

(22) Filed: Jan. 6, 2025

Related U.S. Application Data
(60) Provisional application No. 63/618,155, filed on Jan. 5, 2024.

(51) Int. Cl. F24T 10/13; E21B 36/00; E21B 43/26; F28D 20/00

(52) U.S. Cl. CPC F24T 10/13; E21B 36/006; E21B 43/26; F28D 20/0034; F28D 2020/0047

(57) ABSTRACT

Systems and processes are disclosed for enhanced geothermal energy production. The enhanced closed-loop geothermal system may include a wellbore, where at least a portion of the wellbore penetrates a geothermal heat source, a closed-loop geothermal system deployed in the wellbore, and a heat-buffer including a heat-buffer material disposed within the portion of the wellbore penetrating the geothermal heat source and accumulate heat when working fluid is not circulating and release it to the closed-loop geothermal system when working fluid is circulated. The closed-loop geothermal system deployed in the wellbore, includes a downhole heat exchanger deployed within the portion of the wellbore penetrating the geothermal heat source, a bidirectional fluid conduit, wherein a first end of the bidirectional fluid conduit is fluidly connected to the downhole heat exchanger, and a heat utilization facility, wherein a second end of the bidirectional fluid conduit is fluidly connected to the heat utilization facility.

### FIELD OF DISCLOSURE

Embodiments of the current disclosure may generally relate to the recovery of greater quantities of heat from subsurface geological formations via the drilling and completion of wellbores.

### BACKGROUND

One of the primary advantages of geothermal energy is its availability on a 24/7 basis. Unlike some other renewable energy sources, geothermal does not depend on the wind blowing or the sun shining. However, even this advantage is not without its limitations. The demand for energy, such as electric power, is not uniform over the course of a day, or from season to season. The consequence of this uneven demand curve is that many geothermal plants must either be operated at less-than-optimal production capacity, or some method is required to store geothermal energy, for example as heat or as electricity, so that the stored energy may be utilized during times of greatest demand. Existing methods include storage in batteries, and heating various materials (e.g., bricks, stone, and minerals, such as salt or sand) in surface facilities.

It has also been proposed that geothermal wells simply be shut in during periods of low production. However, shutting down geothermal energy production during low-demand periods is deleterious to the economics of the geothermal installation and is therefore undesirable.

Storage systems involving heating materials at the surface are necessarily inefficient due to energy losses from the well's heat transfer fluid losing heat to the formation rock while being pumped to the surface and because of energy losses to the environment around the storage system.

Battery storage systems lose energy at every cycle because the laws of thermodynamics require that neither conversion of heat to electricity nor storage followed by discharge of electricity can ever be perfectly efficient. Thus, the efficiency of the total geothermal site is decreased with such storage. Alternatively, molten salt may be heated at depth in the formation, then raised to the surface either by pumping or by some other conveyance mechanism, where the heat they carry may be extracted. However, such systems are mechanically complex and may consume a substantial proportion of the energy in the molten salts.

### SUMMARY

This summary is provided only to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to an enhanced closed-loop geothermal system. The system includes a wellbore, a closed-loop, geothermal system deployed in the wellbore, and a heat-buffer. At least a portion of the wellbore penetrates a geothermal heat source. The closed-loop geothermal system includes a downhole heat exchanger deployed within the portion of the wellbore penetrating the geothermal heat source, a bidirectional fluid conduit, wherein a first end of the bidirectional fluid conduit is fluidly connected to the downhole heat exchanger, and a heat utilization facility, wherein a second end of the bidirectional fluid conduit is fluidly connected to the heat utilization facility. A heat-buffer includes a heat-buffer material disposed within the portion of the wellbore penetrating the geothermal heat source, configured to store heat when the closed-loop geothermal system is not circulating working fluid.

In general, in one aspect, embodiments relate to a process of constructing an enhanced closed-loop geothermal system. The process includes obtaining a wellbore, where at least a portion of the wellbore penetrates a geothermal heat source; disposing a downhole heat exchanger of a closed-loop geothermal system, surrounded by an annulus of heat-buffer material in the portion of the wellbore penetrating a geothermal heat source, where a first end of the downhole heat exchanger is fluidly connected to a first end of a bidirectional fluid conduit; and where a second end of the bidirectional fluid conduit is fluidly connected to a heat utilization facility.

In general, in one aspect, embodiments relate to a process of operating an enhanced closed-loop geothermal system. The process includes pumping, using a pump at an uphole end of a closed-loop flow-path, a cool working fluid in a first direction through a bidirectional fluid conduit disposed within a wellbore; receiving the cool working fluid flowing in the first direction by a downhole heat exchanger disposed within a portion of the wellbore penetrating a geothermal heat source; and forming, by heating with the downhole heat exchanger, a hot working fluid from the cool working fluid, wherein the downhole heat exchanger transfers heat from the geothermal heat source to the cool working fluid. A heat-buffer, including a heat-buffer material configured to store heat when the enhanced closed-loop geothermal system is not circulating working fluid, is disposed in an annulus formed by an exterior surface of the downhole heat exchanger and a wall of the wellbore. The process further includes channeling the hot working fluid in a second direction through the bidirectional fluid conduit to an uphole heat exchanger disposed in a heat utilization facility; and forming, by cooling with the uphole heat exchanger, the cool working fluid by extracting heat from the hot working fluid.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 displays electrical power demand curves for various times of day, days of the week, and seasons of the year;

FIG. 2 depicts a convention closed-loop geothermal system;

FIGS. 3A-3D depicts various bidirectional fluid conduit designs in accordance with one or more embodiments;

FIGS. 4A-4C depict systems in accordance with one or more embodiments;

FIG. 5 depicts a hydraulic fracturing system in accordance with one or more embodiments;

FIG. 6 depicts a system for constructing an enhanced closed-loop geothermal system in accordance with one or more embodiments;

FIG. 7 shows an enhanced closed-loop geothermal system in accordance with one or more embodiments;

FIG. 8 shows a flowchart in accordance with one or more embodiments;

FIG. 9 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details or with modifications to them. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a heat exchanger” includes reference to one or more of such heat exchangers.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

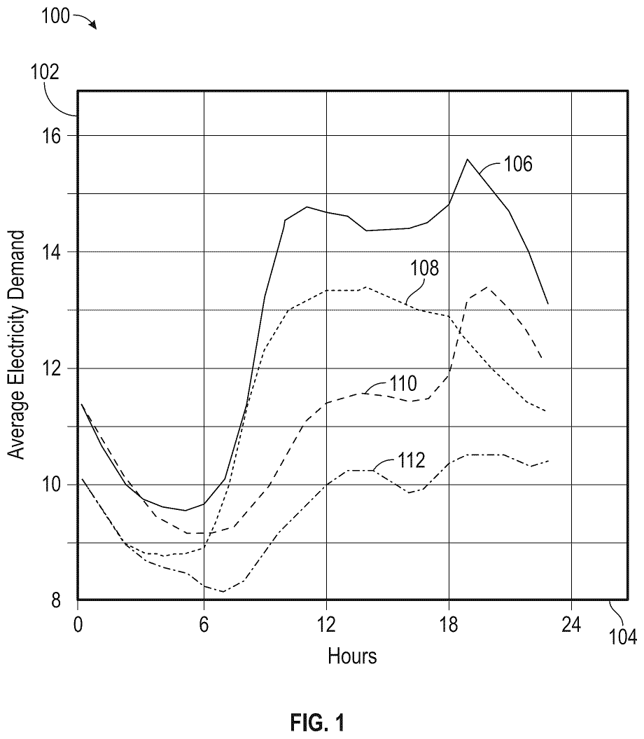

In the following description of FIGS. 1-9, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Energy demand, particularly electricity demand in any given market, may vary on a number of timescales, such as over the course of a day, from season to season, as well as longer term trends. FIG. 1 illustrates this typical behavior. FIG. 1 shows a plot (100) of electricity demand against time of day, specifically for a small European nation, although similar plots could be made for a large city, a state in the USA, or any other jurisdiction. Electricity demand is displayed on the vertical axis (102) and time of day running zero hours (midnight) to 24 hours (the following midnight) on the horizontal axis (104). Displayed are demand values for a typical weekday in the winter (106), a typical weekday in the summer (108), a typical weekend day in the winter (110), a typical weekend day in the summer (112).

It is clear from plot (100) that electricity demand can vary significantly during the day in both winter and summer. Similarly, electricity demand may be significantly different between a weekday and a weekend day. Further electricity demand may be significantly different between winters and summers.

While the details of electricity demand variation may display different characteristics in different markets, significant temporal variations in electricity demand are common. For example, markets in hot climates, where electricity use for air conditioning is common will show high demand during the afternoon hours and during the summer months, and lower demand during the nighttime hours and winter months, while conversely markets in cold climates, where electricity use for heating is common, may show high demand during the nighttime hours and winter months and lower demand during daytime hours and summer months.

Time varying electricity demand can be problematic for many electricity generation technologies as capacity must be matched to maximum demand while low demand leads effectively to wasted capacity (and increased unit costs due to under-utilization of capital investment). This is also true of geothermal energy where attempted production of electricity (and hence heat from the geothermal heat source) will lead to an undesirable drop of temperatures around the wellbore producing the heated working fluid, e.g., hot water or steam.

Disclosed herein are methods for buffering the heat provided to the wellbore from a geothermal system, particularly a closed-loop geothermal system, allowing heat to flow from a geothermal heat source into the wellbore at a near-constant rate, where it is then stored and made available for extraction and use on a time varying basis to match demand.

Hot-rock geothermal systems extract heat from hot underground rock formations, typically located at a depth of several thousand feet below the surface, and transport it to facilities on the surface where it is used for a variety of beneficial purposes, such as, without limitation, the generation of electric power, the heating of residential, commercial, and industrial facilities, and in various industrial and/or chemical processes. Conventional geothermal systems (CGS) typically include two wellbores, an injection wellbore and an extraction wellbore drilled into a highly permeable and hot rock formation. A fluid, typically water or brine, is injected through the injection wellbore, percolates or flows through the permeable rock formation during which it is heated by the rock and is then extracted through the extraction wellbore. CGS are becoming less popular because it is increasingly difficult to find geothermal resources with the required abundance of fluid, usually brine, in sufficiently permeable rock. Sufficiently high permeability allows circulation system of hot brine to a production well that conveys the brine to the surface. Specialized surface equipment then extracts energy from the fluid, and the now-cooled brine is usually re-injected into the formation and the cycle is repeated.

So-called Enhanced Geothermal Systems (EGS systems) have been proposed as a solution to the permeability limitations of CGS. EGS systems are similar in concept to CGS, except that they are established in heated non-porous and lower permeability rock formations that may or may not contain suitable quantities of fluid. To create or enhance subsurface permeability, stimulation techniques are used by drillers to induce fractures in rock comprising the geothermal formation. Although these fractures may only be millimeters wide, they must be a minimum of several hundred meters long to allow sufficient heat transfer from the rock into the fluid. The heated fluid can then be recovered and treated in a CGS system. EGS has not achieved commercial viability and success has been limited to a handful of sites. In addition, the persistent risk that large-scale stimulation may induce seismic activity has not been successfully mitigated. Moreover, achieving a successful stimulation campaign is difficult and expensive, and requires enormous quantities of water, which is scarce in many regions of the world, including the Western US, that have suitable hot subterranean rock formations.

As a result of these limitations of CGS, so-called “Advanced Geothermal Systems” (AGS) have been introduced. AGS are closed-loop systems that do not require any formation fluids to be extracted from the subsurface or need high subsurface permeability. In AGS a heat transfer fluid (“working fluid”) continuously circulates through one or more pipes that traverse a geothermally heated formation before returning to the surface. This property enables AGS systems to operate in a broad range of geological and geophysical settings, including hot dry rock areas where rock permeability is very low, or even zero. AGS systems substantially reduce project risk because they do not depend on either finding or creating subsurface permeability. The performance of closed-loop systems can be optimized by selecting or altering the chemistry of the heat-transfer fluid. AGS systems are easier to operate and maintain because there is very little danger of either contaminating the formation fluid or of the corrosive properties of many formation fluids proving detrimental to the piping system.

Typically, the heat is extracted at depth and transported to the surface using a working fluid, often water. In a closed-loop geothermal system, a closed-loop flow-path is provided, where relatively cool working liquid is pumped down a first tubular (pipe) in a wellbore running from the surface to the source of geothermal heat. The cool working fluid is heated, using a downhole heat exchanger, such as a coaxial downhole heat exchanger (DBHX) and the resulting hot working fluid and/or gas, such as steam, is allowed to flow, or is pumped, up a second tubular to the surface where the heat is extracted, using a turbine linked to a generator or often with the aid of a heat exchanger on the surface. After the heat is extracted at the surface, the resulting cool working fluid then repeats the cycle.

Downhole, heat is provided to the working fluid by the surrounding hot rocks that form the geothermal heat source. However, unless the working fluid flow rate is carefully regulated, in the process of heating the cool working fluid received from the surface the surrounding rocks are cooled and the closed-loop geothermal system loses efficacy. Additional heat may flow into the rocks surrounding the wellbore from more distant regions of the subsurface to replace the heat supplied to the working fluid. However, this heat flow through the rocks may be slow in comparison to the rate needed to effectively operate the closed-loop geothermal system continuously. This may be particularly true when the geothermal heat source is composed of low permeability rocks through which formation fluid may percolate slowly, if at all. In such low permeability rocks the primary mechanism for heat flow may be conductive heat flow which for most rocks is typically very slow on human timescales or the life-span of the AGS.

In addition, for closed-loop systems deployed in hot dry rock formations, the heat exchanger and connecting conduits conveying working fluid to and from the heat exchanger may be insulated from the rock by poorly conducting gases, including air, that fill the annulus between the closed-loop system and the wellbore and act as a thermal insulator between the hot rock and the closed-loop system. Herein, the term “geothermal fluid” shall encompass both naturally occurring fluids present in pores of the source rocks, residual drilling and stimulation fluids remaining after drilling and completion of the wellbore, and fluids introduced into the wellbore and the surrounding rocks for the purpose of facilitating heat transfer from the subsurface formation to the closed-loop system. We note that the geothermal fluid may include, without limitation, the original pore fluid of the rock formation, i.e., the formation fluids contained in the formation of the rock, drilling mud, stimulation fluid, and or other fluid placed in the wellbore, or any combination of the above. Herein, geothermal fluid is distinguished from the working fluid of the closed-loop geothermal system by the fact it is not permitted to flow uphole or downhole within the tubulars forming the closed-loop system, nor to mix directly or indirectly with the working fluid of the closed-loop geothermal system. Energy is extracted from the working fluid at the surface to create electric power or for direct use such as industrial processes.

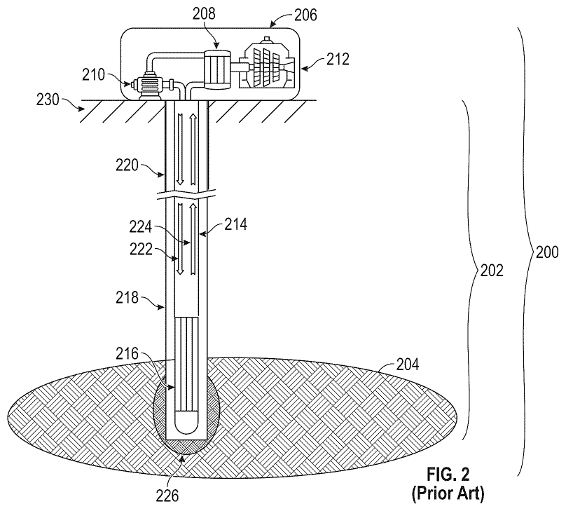

FIG. 2 depicts the elements of a conventional closed-loop geothermal system (200) together with a method of operation. The system comprises a wellbore (202) running from the surface of the earth (230) to a geothermal heat source (204) in the subsurface. Typically, the heat source (204) will be one or more rock formations characterized by an elevated temperature that may lie at intervals to a depth of several thousand feet below the surface of the earth (230). Often the rock formation may be a volcanic pluton, solidified from molten lava injected by volcanic or tectonic forces between the surrounding rock formations, and may have a low fluid permeability. The wellbore (202) may be substantially vertical, as shown, or may be significantly deviated. The wellbore (202) may also have horizontal portions, or even have portions that become shallower with increasing distance along the wellbore.

Portions of the wellbore may be cased, typically with steel pipe, to form a cased hole section (220). Typically, at least the shallowest portions of the wellbore may be cased to provide mechanical stability to the wellbore and/or to isolate near-surface ground water, including drinking water aquifers from fluid originating at deeper depths and/or the drilling fluids used to create the wellbore (202). Often the casing will be cemented into place, using an annular sheath of cement between the exterior surface of the casing and the rock wall of the wellbore. In some cases, multiple sets (“strings”) of casing (not shown) may be present, disposed within one another and substantially sharing a common axis. Other portions of the wellbore (202) may be left uncased to create “openhole” portions (218) of the wellbore (202). While casing essentially isolates the interior of the cased hole section (220) from the fluids in the surrounding rock formation and provides additional thermal insulation in the form of one or more layers of steel and cement, openhole portions (218) permit fluid, including hot fluid, and heat to flow more easily into and out of the openhole portion (218).

At, near, or above the surface of the earth (230) the wellbore (202) may connect to a heat utilization facility (206). The heat utilization facility (206) may include, without limitation, one or more heat exchangers, such as an uphole heat exchanger (208) to extract heat energy from the hot working fluid (224), and/or one or more turbines, such as turbine (212) to generate electrical power. The uphole turbine(s) may be connected to the uphole heat exchanger(s) (208) or connected directly to the tubulars carrying the hot working fluid (224) uphole.

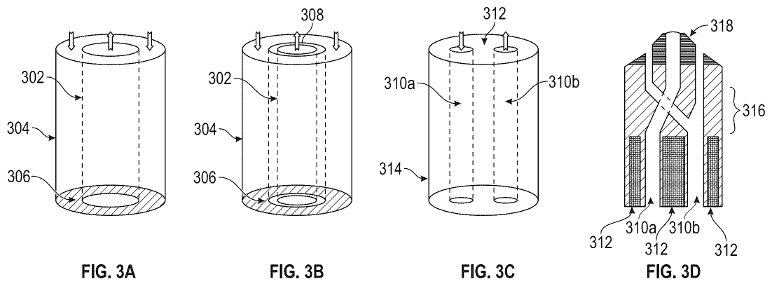

In accordance with one or more embodiments, a downhole heat exchanger (216) may be deployed within the wellbore (202). The downhole heat exchanger (216) may function to heat a cool working fluid (222) supplied to it by transferring heat from hot geothermal fluid surrounding the downhole heat exchanger (216) and producing hot working fluid (224). Tubulars (pipes) must fluidically connect the downhole heat exchanger (216) with the heat utilization facility (206) on the surface of the earth (230), and particularly with the uphole heat exchanger (208), allowing cool working fluid (222) to flow, or to be pumped, for example by uphole pump (210), downhole, and hot working fluid (224) to flow uphole. The tubulars must be configured to allow cool working fluid (222) to flow in one direction and hot working fluid (224) to flow in the opposite direction without mixing with one another. Examples of designs for such a bidirectional fluid conduit (214) are shown below in FIGS. 3A-3D.

Cool working fluid (222) may extract heat, for example using downhole heat exchanger (216), from the geothermal heat source (204), i.e., the hot rock formation. However, particularly in low permeability rocks the extraction of heat will cool the rock formation in a region surrounding the downhole heat exchanger (216), causing the temperature of this restricted zone (226) surrounding the downhole heat exchanger (216) to cool. Since many rocks are poor conductors of heat, and in low permeability rocks hot fluids cannot easily percolate into the restricted zone (226), the extracted heat cannot be easily replaced from more distant portions of the geothermal heat source (204) and the efficacy of the system may decrease over time. However, with careful regulation of flow, the system can reach a point of near equilibrium where the decline in power generation will be very slow over the lifecycle of the well.

In some embodiments of the closed-loop geothermal systems disclosed herein, a pre-existing wellbore (202) may be used. For example, a wellbore previously drilled to provide fresh water, for geotechnical purposes, for open-loop geothermal purposes, or for hydrocarbon exploration may be used or extended for the closed-loop geothermal inventive system. In other embodiments, the wellbore (202) may be drilled specifically for the construction of the closed-loop geothermal invention using a wellbore drilling system.

FIGS. 3A-3D depict examples of bidirectional fluid conduit designs in accordance with one or more embodiments. FIG. 3A shows a first design for a bidirectional fluid conduit (214). In FIG. 3A the bidirectional fluid conduit design includes two co-axial pipes with a first pipe (302) disposed within a second pipe (304). In some embodiments, the total cross-sectional area of the second pipe (304) may be essentially double the cross-sectional area of the first pipe (302), so that the cross-sectional area through which fluid can flow in one direction within the first pipe (302) is equal to the cross-sectional area of the annulus (306) through which fluid may flow in the reverse direction. For example, cool working fluid may flow in a first direction (downhole) in the central pipe (302) while hot working fluid may flow in the reverse direction (uphole) through the annulus, or vice versa.

It is essential to thermally isolate the two fluids from one another as much as is practical. Accordingly, as shown in FIG. 3B a thermally insulating layer or annulus (308) may be disposed between the first pipe (302) and the annulus (306). Alternatively, thermal insulation may be created by construction of the first pipe from a material exhibiting low thermal conductivity.

In other embodiments, the bidirectional fluid conduit (214) may include two pipes (310a) and (310b) of substantially equal cross-sectional areas running substantially parallel to each other side-by-side and embedded within a thermally insulating material (312) that in turn fills an exterior tubular (314), as shown in FIG. 3C. Typically, bidirectional fluid conduits (214) are manufactured in segments that may be 30-50 ft in length and multiple such segments are screwed together as they are deployed in the wellbore until they reach the desired length that may be several thousand feet in total. To allow the segments to be screwed together they may include a “male” screw thread (318), as shown in FIG. 3D, at one end and a corresponding “female” socket at the opposing end (not shown). Each segment may also include a cross-over section (316) at each end that transforms a side-by-side design to an annular form to facilitate the connect of the first pipe (310a) in a first segment to the first pipe in a second adjacent segment, and the second pipe (310b) in the first segment to the second pipe in the second adjacent segment.

As discussed above, it is economically desirable to operate closed-loop systems at, or close to, their sustained maximum heat production capabilities, irrespective of whether the produced heat is used for electricity generation, other industrial applications, or residential and commercial heating.

To achieve this goal systems disclosed herein use a “heat buffer” to buffer the heat flow, i.e., allow the heat to continue to flow to the wellbore from regions distant from the wellbore, even while heat is not being extracted from the wellbore via the working fluid, then allow it to be transferred to the working fluid when electricity demand requires. Such a heat flow may only be sustained if the temperature at or near the wellbore is maintained at a lower temperature than the surrounding geothermal heat source (hot rock) even while heat is not being extracted via the working fluid of the closed-loop geothermal system. This requirement is met in embodiments herein using a means of storing heat in the wellbore while minimizing the associated increase in temperature as heat is absorbed. A “heat-buffer” material with this property has a high specific heat capacity. A heat-buffer material with a high specific heat capacity can store a large amount of heat with only a small associated increase in its temperature. As a consequence, heat may flow from the geothermal heat source (i.e., the hot rock) to the heat buffer for a period of time, even while the heat is not being extracted by the circulating working fluid. Due to the high specific heat capacity of the heat buffer, even though heat is continuously accumulating within it, the rate of temperature increase of the heat buffer is slow. Thus, heat may continue to flow from the surrounding hot rock driven by the thermal gradient between the hot rock and the heat-buffer for an extended period of time, and until the circulation of the working fluid in the closed-loop geothermal system recommences.

In addition to possessing a high specific heat capacity, suitable heat-buffer materials useful in embodiments herein have a high boiling temperature—the temperature at which it changes phase to become a gas. Changing phase to become a gas has the undesirable properties of greatly increasing the volume and/or pressure of the material and greatly reducing its density-producing a tendency to fracture the rock around the wellbore, damage equipment, such as heat exchangers within the wellbore, and/or migrate rapidly up the wellbore. Consequently, the heat-buffer should remain liquid at temperatures it is likely to experience downhole, i.e., the geothermal heat source temperatures, and above. Finally, the heat-buffer material with mass density greater than water is desirable to prevent any tendency for it to migrate up the wellbore under its own buoyancy. In summary, heat-buffer materials useful in embodiments herein should have a high specific heat capacity, a boiling point (at the downhole pressure) higher than the temperature of the geothermal heat source, and a density (at the downhole temperature) greater than the liquid otherwise filling the wellbore, e.g., water.

Although water itself has an extremely high specific heat capacity (approximately 4,184 J kg⁻¹ K⁻¹), it has an extremely low boiling point (100° C.) that is much lower than the temperature required for many geothermal applications, such as economic generation of electricity. For example, typical heat sources for production of electrical power from geothermal heat have temperatures in the range from 150-350° C. Further, the density that makes water prone to migrating up the borehole when warmer than cooler water closer to the surface. A much better choice for a downhole heat-buffer material useful in embodiments herein is a molten salt. There are a number of different choices of molten salt, but a typical molten salt has a specific heat capacity of approximately 1,530 J kg⁻¹ K⁻¹; a boiling point of between 600˜1000 degrees C.; and a density 1,900 kg m⁻³. Examples of the melting point (“minimum working temperature”) and boiling points (“maximum working temperature”) for a variety of molten salts, including mixtures of sodium nitrate (Na NO₂) and potassium nitrate (K NO₂), are given in Table 1.

TABLE 1

| Working | | Working | | Composition (%) | | | | | | | | |
|---|---|---|---|---|---|---|---|---|---|---|---|---|
| Range (deg F.) | | Range (deg C.) | | | | | | | | | BaCl₂ + | |
| Min | Max | Min | Max | NaNO₂ | NANO₃ | KNO₃ | Na₂CO₃ | NaCl | KCL | BaCl₂ | SiO₂ | CaCl₂ |
| 325 | 1099 | 163 | 593 | 37-50 | 0-10 | 50-60 | | | | | | |
| 550 | 1099 | 288 | 593 | | 45-57 | 45-57 | | | | | | |
| 1150 | 1701 | 621 | 927 | | | | 45-55 | | 45-55 | | | |
| 1099 | 1650 | 593 | 899 | | | | | 15-25 | 20-32 | 50-60 | | |
| 1026 | 1400 | 552 | 760 | | | | | 10-15 | 25-30 | 40-45 | | 15-20 |
| 1299 | 1650 | 704 | 899 | | | | | 40-60 | 40-60 | | | |
| 1650 | 1999 | 899 | 1093 | | | | | | 5-15 | 85-95 | | |
| 1900 | 2401 | 1038 | 1316 | | | | | | | | 98 | |
| 1650 | 2350 | 899 | 1288 | | | | | 3-7 | | 93-97 | | |

In geothermal applications, mixtures of nitrate salts are preferred, since they are generally less corrosive to the metallic elements of a geothermal well than halide salts. Preferred nitrate salt mixtures include, but are not limited to:
“Solar salt,” a 60/40 mixture by weight off sodium nitrate (NaNO3) and potassium nitrate (KNO3); its melting point is approximately 222° C. It is called solar salt because of its common application in concentrated solar systems.
Yara's Salt, a proprietary blend of calcium, potassium, and sodium nitrates, with a melting point of 131° C.
Li/Na/K ternary mixture, a mixture of lithium nitrate (LiNO3), sodium nitrate (NaNO3) and potassium nitrate (KNO3); its melting point ranges from 116° C. to 124° C., depending on the exact composition.
Quaternary mixtures of lithium, sodium, and potassium nitrates with potassium nitrite (KNO2); the melting point depends on the exact composition, but some quaternary mixtures have a greater heat capacity than the ternary mixtures.

In addition, to ensuring that heat will continue to flow into the wellbore by maintaining a temperature gradient between the wellbore and surrounding region, it may be desirable to enhance the background thermal conductivity of the rock in the surround region to increase the rate of heat flow. This may be achieved by infusing the pore spaces in the surrounding rock, or naturally occurring fractures with a material having a high thermal conductivity. Further, in geothermal heat source regions with low natural porosity and permeability, it may be helpful to generate anthropomorphic fracture networks, for example by using hydraulic fracturing, and/or increasing the natural porosity and permeability using other stimulation techniques such as acidizers.

In accordance with one or more embodiments, a high thermal conductivity material may be injected into either existing natural fractures surrounding the wellbore, or into hydraulic fractures radiating from the wellbore. This injection may be particularly effective at creating high thermal conductivity pathways through rocks with very low porosity, permeability, and or low moisture content, to allow heat to flow in geothermal formation fluids from regions surrounding the wellbore into the wellbore where it may be stored, until needed for production, by the heat-buffer material. In addition to high thermal conductivity, it may be advantageous that a material used to form these high thermal conductivity pathways is composed of small particles, e.g., fine particles that enable it to be pumped into narrow cracks and fracture. For example, graphene and some metal-organic heat carriers, typically consisting of cage-or open-sphere shaped large organic molecules into which metallic ions are incorporated, may be suitable.

In some embodiments graphene may be used to form the high thermal conductivity pathways. Graphene has a melting point of approximately 3670 degC (and a boiling point of 4,200 degC well above the temperature of commercially utilized thermal heat sources. Graphene also has a thermal conductivity between 1,300 and 5,000 watts per meter per Kelvin (W/mK), depending on the method of measurement and the purity of the graphene, making it superior for this application to copper, that has a thermal conductivity of only 400 W/mK and a melting point around 1085 deg C.

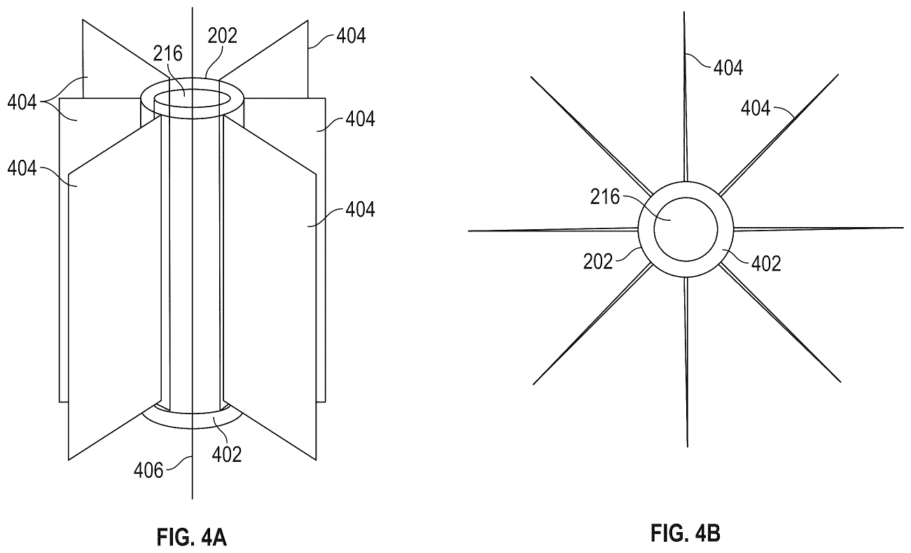

FIGS. 4A and 4B shows idealized elements of a closed-loop geothermal system including a heat-buffering material (402), and a network of high thermal conductivity pathways (404) in accordance with one or more embodiments. Specifically, FIG. 4A shows three dimensional perspective view of a downhole heat exchanger (216) disposed inside a wellbore (202) at a depth where the wellbore (202). The annulus between the downhole heat exchanger (216) and the wall of the wellbore (202) is filled with a heat-buffering material (402). Radiating out away from the wellbore (202) are six idealized fractures filled with a high thermal conductivity material to form high thermal conductivity pathways (404). In some embodiments, the downhole heat exchanger (216), filled annulus of heat-buffer material (402), and high thermal conductivity pathways (404) may share the same vertical extent along the wellbore (202), while in other embodiments the heat exchanger (216), filled annulus of heat-buffer material (402), and high thermal conductivity pathways (404) may each have different extents along the wellbore (202). In some embodiments, the heat exchanger (216), filled annulus of heat-buffer material (402), and high thermal conductivity pathways (404) may all extend across the full depth range of the geothermal heat source penetrated by the wellbore, while in other embodiments they may have a greater or a lesser extent than the full depth range of the geothermal heat source penetrated by the wellbore. The extent of the high thermal conductivity pathways (404) in the radial direction away from the wellbore (202) may vary from one embodiment to another, nor need each high thermal conductivity have the same radial extent as the others. However, in typical embodiments, the high thermal conductivity pathways (404) may extend approximately 100 ft away from the wellbore (202) in an approximately radial direction.

FIG. 4B depicts the idealized elements of the closed-loop geothermal system in cross-section normal to the wellbore axis (406), i.e., in map view. Although the downhole heat exchanger (216) is shown as centered in the wellbore (202), the heat-buffer material (402) forming a symmetrical annulus between downhole heat exchanger (216) and the wall of the wellbore (202), and the high thermal conductivity pathways (404) as evenly spaced, this is unlikely to be the case in practice and should not be interpreted as limiting the scope of the invention.

FIG. 4C shows a cross-section through a more typical embodiment. A wellbore (202) penetrates a geothermal heat source containing a network of natural fractures (440). The network of natural fractures (440) contains a plurality of fractures that may have orientations that are not isotropic, i.e., the natural fractures may have one or more preferred orientations, influenced by current and past stress fields. In addition, in accordance with one or more embodiments, hydraulic fractures (442) may emanate from the wellbore (202) in one or more preferred direction. The downhole heat exchanger (216) may be disposed in an off-centered manner, displaced from the axis of the wellbore (202). In some embodiments, the hydraulic fractures may be fully or partially filled with a high thermal conductivity material to form high thermal conductivity pathways. In some embodiments, the fractures within a portion (444) of the network of natural fractures (440) surrounding the wellbore (202) may be fully or partially impregnated by the high thermal conductivity material. The portion (444) may be circular or elliptical (as shown) in cross-section, but in general may have an irregular shape influenced by the fluid conductivity of the network of natural fractures (440). The shape of the portion (444) should not be interpreted as limiting the scope of the invention.

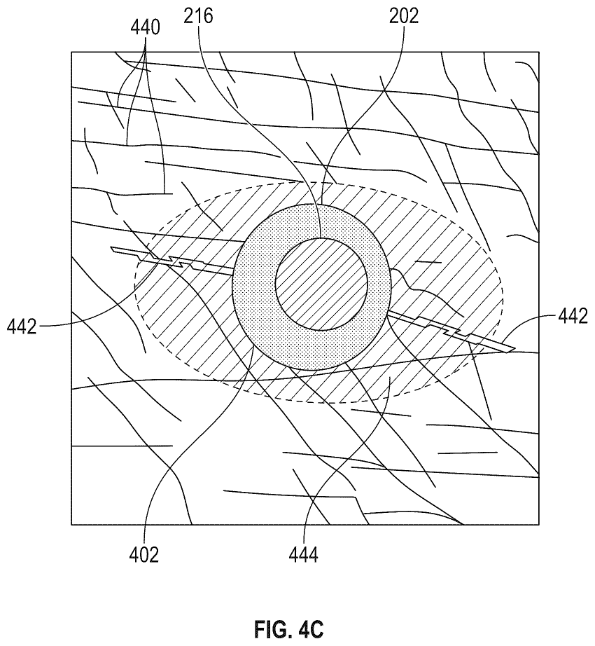

FIG. 5 illustrates a stimulation system, specifically a hydraulic fracturing system (500) performing a hydraulic fracturing operation in accordance with one or more embodiments. The hydraulic fracturing system (500) and hydraulic fracturing operation are for illustration purposes only. The scope of the disclosure is intended to encompass any type of hydraulic fracturing system (500) and hydraulic fracturing operation. However, the hydraulic fracturing system used in embodiments may often be a small scale, “slimmed-down”, or minimal system, as will be described below. This has the advantage of reducing unnecessary cost, time, and environmental impact.

In some embodiments, the hydraulic fracturing operation is performed by separating the wellbore (202) into multiple wellbore lengths separated by packers (510a-c) that hydraulically isolate the intervening lengths, sometimes termed “stages”, e.g., stages (512a-c). Each stage may be connected by tubing (506) to a set of valves attached to the wellhead at the surface, sometimes termed a “frac tree” (508). In some embodiments, a first packer (510a) may be installed near the toe (514) of the wellbore (202) to form a first stage (512a) to be fractured. Then a second packer (510b) may be installed to form a second stage (512b) between the first packer (510a) and the second packer (510b) to be fractured. Similarly, additional packers, e.g., packer (510c), may be installed sequentially one at a time to form additional stages, e.g., stage (512c) that may be fractured prior to the installation of the next pack in the sequential series. In other embodiments, a plurality of packers (510a-c) may be installed first with each stage connected to the tubing (506) from the frac tree (508) before isolating and fracturing each stage (512a-c) sequentially using valves (not shown) within the tubing (506). Typically, the tubing (506) and all the packers (510a-c) are removed from the well after the hydraulic fracturing is completed. In general, a single wellbore (202) may have anywhere from one to more than forty stages, however for the embodiments described herein typically only a small number of stages are contemplated. For example, a lower stage (closest to the toe of the sidetrack), and intermediate stage (near the middle of the sidetrack), and an upper stage (near the intersection of the sidetrack with the primary wellbore). Often this small number of stages and stimulations will be adequate to provide the necessary permeability channels.

In an openhole portion of the wellbore, hydraulic fracturing may, for each stage, include a pumping operation where high pressure fluid is pumped into the stage until the surrounding rock fractures. In cased-hole portions each stage may also include a perforation operation where holes are formed through the casing, often with the aid of shaped explosive charges.

FIG. 5 shows a “frac-tree” (508) (similar to a “production-tree” but is specifically installed for the hydraulic fracturing operation, with larger bores, higher-pressure ratings and abrasive resistant materials. FIG. 5 further shows chemical storage containers (530), water storage containers (532), and proppant storage containers (534) that are constituents of the hydraulic fracturing system (500). In some embodiments disclosed herein, proppants and hence proppant storage containers (534) are not necessary, and the proppant storage containers (534) may be omitted. However, in other embodiments, the proppants may be composed of grains of a material exhibiting a high thermal conductivity. Frac lines (536) transport the chemicals, proppant, and water from the storage containers (530), (532), (534) into a frac blender (538).

The frac blender (538) blends the water, chemicals, and proppant to become the frac fluid that is then channeled to one or more frac pumps mounted on pump trucks (540), to be pumped through the frac tree (508) into the well. The frac fluid is transported from the frac manifold to the frac tree (508) using frac lines (536).

Initially, high fluid pressure creates the hydraulic fractures, e.g., hydraulic fracture (542), later proppant, such as sand, may be pumped into the hydraulic fractures where the proppant props open the fractures (542) once the fluid pressure is released. Different chemicals may be used to lower friction pressure, prevent corrosion, etc. The pumping operation may be designed to last a certain length of time to ensure the fractures (542) have sufficiently propagated. Further, the frac fluid may have different make ups throughout the pumping operation to optimize the pumping operation without departing from the scope of the disclosure herein.

In some embodiments, acidizing may be performed as well as, or instead of, hydraulic fracturing, particular when the rock formation surrounding the wellbores are alkali in nature, such as carbonate and dolomite rocks. In these circumstances an acidic fluid may be pumped into the naturally existing fractures, the pores of the rock (where some background permeability exists) or into the hydraulic fractures to etch the rock surfaces to increase their permeability.

In some embodiments, a hydraulic fracturing fluid may initially include an oil- or water-based liquid. This hydraulic fracturing fluid may be pumped into the wellbore until sufficient pressure is reached downhole to fracture the wellbore and generate hydraulic fractures. At this stage a proppant, such as a fine sand, may be mixed into the hydraulic fracturing fluid to form a “slurry” and a portion of this slurry may be pumped into the newly created hydraulic fractures where it may deposit the proppant such that when the hydraulic pressure is released the proppant prevents the hydraulic fractures from closing. In some embodiments, the proppant may consist of a high thermal conductivity material such as graphene, while in other embodiments the proppant may be a mixture of a conventional proppant, such as sand and a high thermal conductivity material, such as graphene. Such a mixed proppant may provide both enhanced thermal conductivity and mechanical strength to keep the propped hydraulic fracture open. In accordance with one or more embodiments, the slurry may vary as a function of pumping time. For example, after the hydraulic fractures have been created, a slurry containing a high thermally conductive material may be pumped followed by a slurry containing a conventional proppant. Alternatively, the slurry containing the high thermal conductivity material may be pumped first, after the creation of the hydraulic fractures, followed by the slurry containing a conventional proppant.

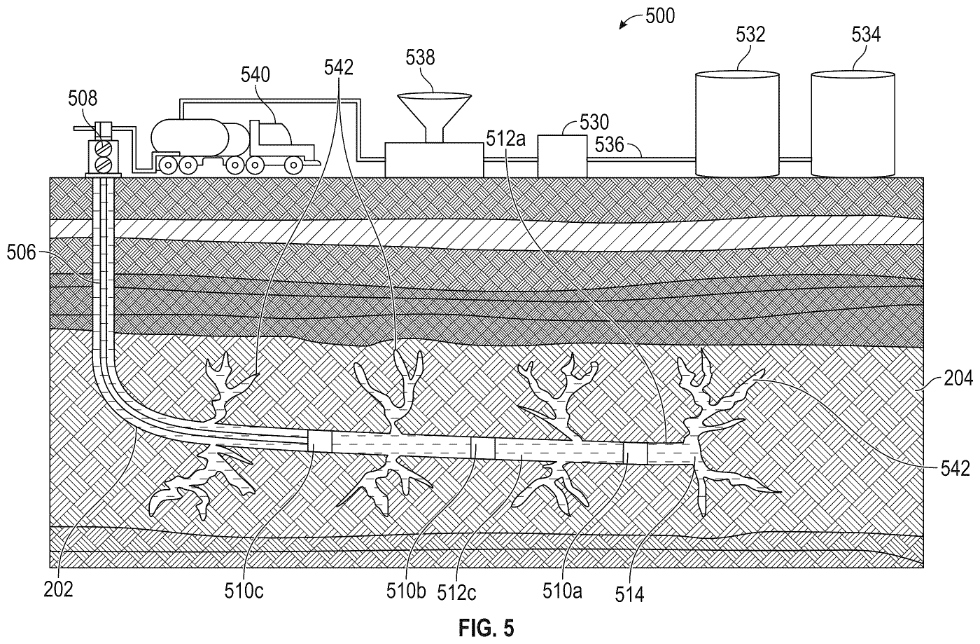

By way of illustration, FIG. 6 depicts one method and system of emplacing heat-buffering material (602) downhole in accordance with one or more embodiments. The system includes a wellbore (202) that may include an openhole portion (218), a cased hole section (220), and be capped by a wellhead (604) at the surface. In some embodiments, high thermal conductivity pathways (404) may extend from an openhole portion (218) of the wellbore (202) into the surrounding geothermal heat source (204). In other embodiments, the bottom portion of the wellbore may have been cased after the high thermal conductivity pathways have been created, or the high thermal conductivity pathways may have been created after the bottom of the wellbore has been cased, for example by creating holes in the casing near the bottom of the wellbore, e.g., by perforating the casing, and pumping the proppant through the holes in the casing. Further, in some embodiments, a portion of the wellbore (202) may have been “reemed” to increase the diameter of the portion of the wellbore (202), thereby increasing the volume that is available for the heat-buffering material (602) to occupy.

In the coiled tubing system shown, a coil tubing (606) may extend from a coil tubing spool or reel (608), supported on a “goose-neck” (610), though an injector head (612) and the wellhead (604) and into the wellbore (202). Both the goose-neck (610) and the injector head (612) may be suspended from a crane or derrick (not shown), or be supported by a scaffolding (630).

The coiled tubing (606) may be connected, via surface tubing (620) and one or more pumps (622), at the coiled tubing reel (608), to a storage tank (624) containing heat-buffer material (602). The coiled tubing (606) may extend into the wellbore (202), and in some embodiments, the coiled tubing (606) may extend into the portion of the wellbore (202) where the heat-buffering material is to be placed. In some embodiments, the heat-buffering material may be placed in an openhole portion (218) of the wellbore (202), while in other embodiments there may be no openhole portion (218) and the wellbore (202) may be cased over its entire length.

The heat-buffering material (602) may be pumped into the wellbore through a channel, such as the coiled tubing system (as shown), or a workover rig with drill-pipe or production tubing (not shown). In some embodiments, the heat-buffering material (602) may be heated to a molten state at the surface prior to being pumped into the wellbore (202), while in other embodiments the heat-buffering material (602) in the form of solid granules may be mixed at the surface with a liquid, such as an oil-based mud, to form a slurry and the slurry pumped through the channel, e.g., coiled tubing 606, into the wellbore (202), where the heat-buffering material (602) may be allowed to settle and, if not already molten, to melt under the influence of the temperature of the geothermal heat source.

The emplacement of the heat-buffering material (602) may displace at least a portion of the fluid, such as water or hydraulic fracturing fluid, already filling a portion of the wellbore (202). This displaced fluid (632) may be allowed to escape through the wellhead (604) via a fluid channel into one or more containers, such as mud-pits (634).

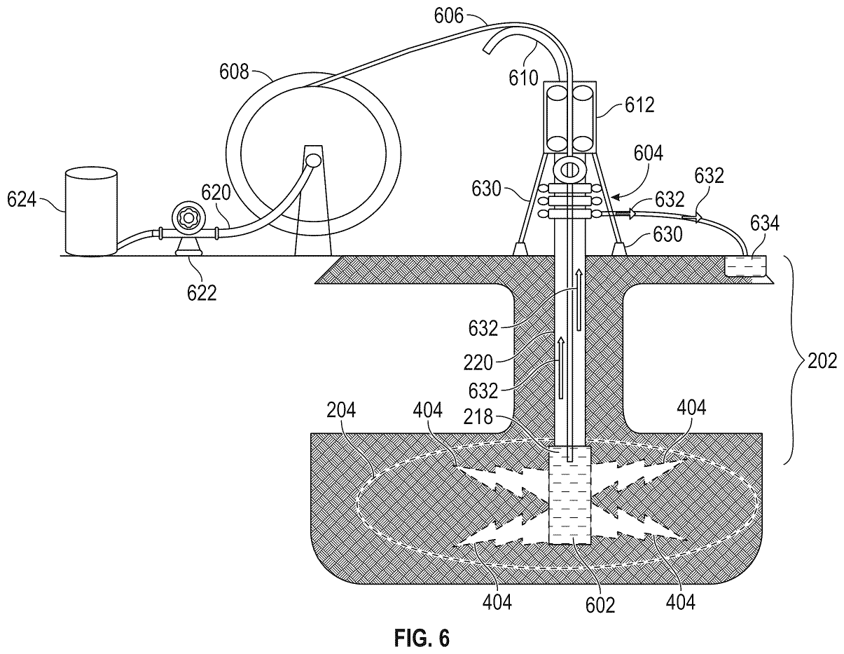

In some embodiments, the final step in the construction of the enhanced closed-loop geothermal system (700) may require the insertion of the downhole heat exchanger (216) attached to a bidirectional fluid conduit (214) and into the molten heat-buffering material, e.g., molten salt, as shown in FIG. 7.

While FIG. 6 illustrates a deployment of heat buffering material using a coiled tubing unit, however this should not be interpreted as limiting the scope of the invention. For example, in other embodiments the coiled tubing may be replaced by a conventional drilling rig, a stripped down drilling rig, or a work-over rig without departing from the scope of the invention.

FIG. 7 shows an enhanced closed-loop geothermal system in accordance with one or more embodiments. For concision, a full description of components and/or elements depicted in FIG. 7 is not provided anew for those components and/elements that have been previously described with reference to the preceding figures, specifically FIG. 2. However, the enhanced closed-loop geothermal system (700) shown in FIG. 7 differs from a conventional closed-loop geothermal system (200) in, at least, the following ways. In accordance with one or more embodiments, the downhole heat exchanger (216) of the enhanced closed-loop geothermal system (700) is at least partially surrounded and enclosed by a heat-buffer material (602), configured to continue to absorb heat from the surrounding geothermal heat source (204) for at least a non-zero period of time after the cessation of the circulation of the working fluid (222, 224). The heat-buffer material (602) may partially or wholly fill the annulus created by the external surface of the downhole heat exchanger (216) and the wall of the wellbore (202).

Further, in accordance with one or more embodiments, a plurality of high thermal conductivity pathways (404) may extend from the wellbore (202) into the geothermal heat source (204) surrounding the wellbore (202). The plurality of high thermal conductivity pathways (404) may be formed from fractures partially or wholly filled with a high thermal conductivity material, such as graphene. In some embodiments, the fractures may be natural fractures that existed prior to the drilling of the wellbore (202), in other embodiments the fractures may be drilling-induced fractures caused by processes, such as stress changes, that result from the drilling operation. In still other embodiments, the fractures may be hydraulic fractures produced by elevating the pressure of fluid filling the wellbore (202) above the fracture threshold of the rock surrounding the wellbore (202). In still further embodiments the fractures may include any two or more of natural fractures, drilling-induced fractures, and hydraulic fractures.

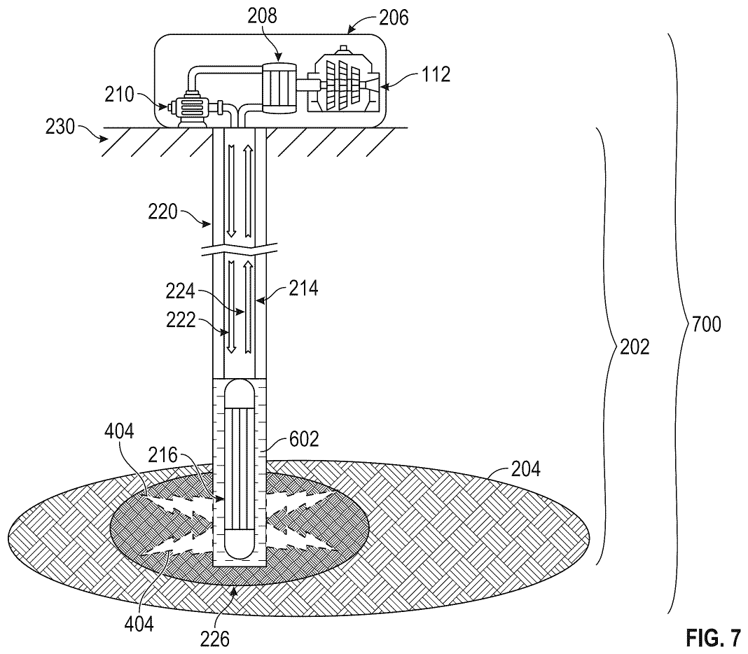

FIG. 8 shows a flowchart (800) for a process of constructing an enhanced closed-loop geothermal system in accordance with one or more embodiments.

In Step (802) a wellbore (202) may be obtained where at least a portion of the wellbore (202) penetrates a geothermal heat source (204). In Step (804) a downhole heat exchanger (216) of a closed-loop geothermal system may be disposed in the wellbore (202), surrounded by an annulus of heat-buffer material (602) in the portion of the wellbore (202) penetrating a geothermal heat source (204). In accordance with one or more embodiments, the heat-buffer material (602) may be a molten salt, such as sodium nitrate, potassium nitrate, or a mixture of the two. In some embodiments, the heat-buffer material (602) may have a melting point less than a minimum temperature of the geothermal heat source (204) and a boiling point greater than a maximum temperature of the geothermal heat source (204).

A first end of the downhole heat exchanger (216) may be fluidly connected to a first end of a bidirectional fluid conduit (214), and a second end of the bidirectional fluid conduit (214) may be fluidly connected to a heat utilization facility (206). In some embodiments a plurality of high thermal conductivity pathways (404) may be formed in a zone surrounding the wellbore (202) by injecting a high thermal conductivity material into a plurality of fractures in the zone. In some embodiments, the high thermal conductivity material be graphene. In some embodiments, the plurality of fractures may include one or more hydraulic fractures, one or more drilling-induced fractures, and/or a plurality of natural fractures.

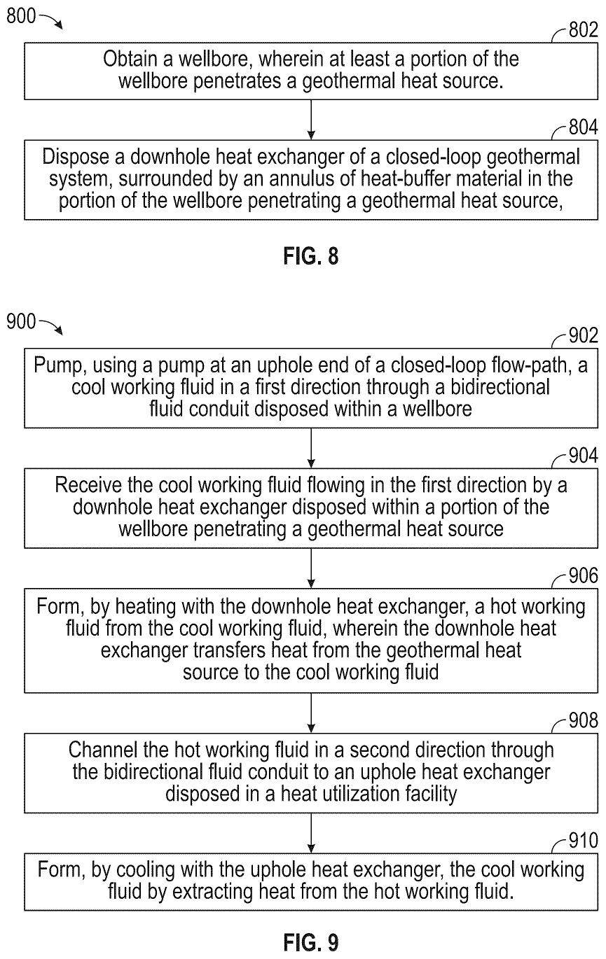

FIG. 9 shows a flowchart (900) for a process of operating an enhanced closed-loop geothermal system in accordance with one or more embodiments. In Step (902) a cool working fluid (222) may be pumped, using a pump (210) at an uphole end of a closed-loop flow-path, in a first direction through a bidirectional fluid conduit (214) disposed within a wellbore (202).

In Step (904) the cool working fluid, flowing in the first direction, may be received by a downhole heat exchanger (216) disposed within a portion of the wellbore (202) penetrating a geothermal heat source (204).

In Step (906) a hot working fluid (224) may be formed, by heating in the downhole heat exchanger (216), from the cool working fluid (222). The downhole heat exchanger (216) may transfer heat from a heat buffer to the cool working fluid (222). The heat-buffer, including a heat-buffer material (602) configured to store heat when the enhanced closed-loop geothermal system (700) is not circulating working fluid (222) and (224), may be disposed in an annulus formed by an exterior surface of the downhole heat exchanger (216) and a wall of the wellbore (202). In some embodiments, the heat-buffer material (602) may include molten salt. In some embodiments, the heat-buffer may further include a plurality of high thermal conductivity pathways disposed in a zone surrounding the wellbore consisting, at least in part, of plurality of fractures at least partially filled with a high thermal conductivity material, such as graphene. The fractures may include at least one of natural fractures, drilling induced fractures, and hydraulic fractures.

In Step (908) the hot working fluid (224) may be channeled in a second direction through the bidirectional fluid conduit (214) to an uphole heat exchanger (208) disposed in a heat utilization facility (206).

In Step (910) cool working fluid (222) may be formed, by cooling in the uphole heat exchanger (208), by extracting heat from the hot working fluid (224).

As described above, embodiments herein provide for a closed-loop geothermal system that may better handle the variation in daily and seasonal energy demand. The use of a buffer material to maintain efficient heat flow to the down bore heat exchanger during use and to store heat during periods of non-use or reduced capacity, while maintaining a temperature gradient promoting heat flow, allows the geothermal system to maintain high efficacy over its lifecycle.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. An enhanced closed-loop geothermal system, comprising:
a wellbore, wherein at least a portion of the wellbore penetrates a geothermal heat source;
a closed-loop geothermal system deployed in the wellbore, wherein the closed-loop geothermal system comprises:
a downhole heat exchanger deployed within the portion of the wellbore penetrating the geothermal heat source,
a bidirectional fluid conduit, wherein a first end of the bidirectional fluid conduit is fluidly connected to the downhole heat exchanger, and
a heat utilization facility, wherein a second end of the bidirectional fluid conduit is fluidly connected to the heat utilization facility; and
a heat-buffer comprising a heat-buffer material disposed within the portion of the wellbore penetrating the geothermal heat source, configured to accumulate and store heat when the closed-loop geothermal system is not circulating working fluid and release it to the closed-loop geothermal system when working fluid is circulated.

2. The enhanced closed-loop geothermal system of claim 1, further comprising a plurality of high thermal conductivity pathways disposed in a zone surrounding the wellbore.

3. The enhanced closed-loop geothermal system of claim 1, wherein the heat-buffer material comprises a molten salt.

4. The enhanced closed-loop geothermal system of claim 3, wherein the molten salt comprises at least one of sodium nitrate and potassium nitrate.

5. The enhanced closed-loop geothermal system of claim 2, wherein the plurality of high thermal conductivity pathways comprises a plurality of fractures at least partially filled with a high thermal conductivity material.

6. The enhanced closed-loop geothermal system of claim 5, wherein the high thermal conductivity material comprises graphene.

7. The enhanced closed-loop geothermal system of claim 5, wherein plurality of fractures comprises hydraulic fractures.

8. The enhanced closed-loop geothermal system of claim 1, wherein the heat-buffer material has a melting point lower than a minimum temperature of the geothermal heat source and a boiling point higher than a maximum temperature of the geothermal heat source.

9. A process of constructing an enhanced closed-loop geothermal system, comprising:
obtaining a wellbore, wherein at least a portion of the wellbore penetrates a geothermal heat source; and
disposing a downhole heat exchanger of a closed-loop geothermal system, surrounded by an annulus of heat-buffer material in the portion of the wellbore penetrating a geothermal heat source,
wherein a first end of the downhole heat exchanger is fluidly connected to a first end of a bidirectional fluid conduit;
wherein a second end of the bidirectional fluid conduit is fluidly connected to a heat utilization facility, and
wherein the heat-buffer material is configured to accumulate and store heat when the closed-loop geothermal system is not circulating working fluid and release it to the closed-loop geothermal system when working fluid is circulated.

10. The process of claim 9, further comprising forming a plurality of high thermal conductivity pathways disposed in a zone surrounding the wellbore by injecting a high thermal conductivity material into a plurality of fractures in the zone.

11. The process of claim 10, wherein the plurality of fractures comprises a hydraulic fracture.

12. The process of claim 10, wherein the high thermal conductivity material comprises graphene.

13. The process of claim 9, wherein the heat-buffer material comprises a molten salt.

14. The process of claim 13, wherein the molten salt comprises at least one of sodium nitrate and potassium nitrate.

15. The process of claim 9, wherein the heat-buffer material has a melting point lower than a minimum temperature of the geothermal heat source and a boiling point higher than a maximum temperature of the geothermal heat source.

16. The process of claim 9, wherein disposing the downhole heat exchanger surrounded by the annulus of heat-buffer material in the portion of the wellbore penetrating a geothermal heat source comprises:
pumping a slurry of solid phases salts into the portion of the wellbore;
allowing the solid phase salts to settle in the portion;
allowing the solid phase salts to melt to form molten salt; and
inserting the downhole heat exchanger into the molten salt.

17. A process of operating an enhanced closed-loop geothermal system, comprising:
pumping, using a pump at an uphole end of a closed-loop flow-path, a cool working fluid in a first direction through a bidirectional fluid conduit disposed within a wellbore;
receiving the cool working fluid flowing in the first direction by a downhole heat exchanger disposed within a portion of the wellbore penetrating a geothermal heat source;
forming, by heating with the downhole heat exchanger, a hot working fluid from the cool working fluid, wherein the downhole heat exchanger transfers heat from the geothermal heat source to the cool working fluid,
wherein a heat-buffer, comprising a heat-buffer material, configured to accumulate and store heat when the enhanced closed-loop geothermal system is not circulating working fluid and release heat to the closed-loop geothermal system when working fluid is circulated, is disposed in an annulus formed by an exterior surface of the downhole heat exchanger and a wall of the wellbore;
channeling the hot working fluid in a second direction through the bidirectional fluid conduit to an uphole heat exchanger disposed in a heat utilization facility; and
forming, by cooling with the uphole heat exchanger, the cool working fluid by extracting heat from the hot working fluid.

18. The process of claim 17, wherein the heat-buffer material comprises a single molten salt or a combination comprising multiple molten salts.

19. The process of claim 17, wherein the heat-buffer further comprises a plurality of high thermal conductivity pathways disposed in a zone surrounding the wellbore.

20. The process of claim 19, wherein the plurality of high thermal conductivity pathways comprises a plurality of fractures at least partially filled with a graphene.
